(19) United States
(12) Patent Application Publication
(10) Pub. No.: US 2002/0073420 A1
(43) Pub. Date: Jun. 13, 2002

(54) Method for transmitting advertisements via electronic mails

(75) Inventor: Sae-Young Yoon, Seoul (KR)

Correspondence Address: SENNIGER POWERS LEAVITT AND ROEDEL, ONE METROPOLITAN SQUARE, 16TH FLOOR, ST LOUIS, MO, 63102, US

(73) Assignee: Incomkorea Co., Ltd.

(21) Appl. No.: 09/912,863

(22) Filed: Jul. 25, 2001

(30) Foreign Application Priority Data
Sep. 7, 2000 (KR) 2000-53138

(51) Int. Cl. H04N 7/16; H04H 9/00

(52) U.S. Cl. 725/23; 725/9

(57) ABSTRACT

The present invention relates to a more improved application than a method for transmitting advertisements via electronic mails enclosing the advertisements together with coupons on the internet.

Information collected through some hierarchical questions upon receipts of coupons by a sender or a receiver of an electronic mail enclosing coupons is used for the analysis of a particular user's tendency. The result of the tendency result is compared and analyzed with the conditions of a sponsor for the use of target advertisements. The target advertisements are enclosed in the electronic mail together with the coupons and can be automatically transmitted to plural users fit for the conditions. The advertisements for the interest fields of the particular user are displayed in priority on prize advertisement menus or the advertisements lowest in the click rate up to date are displayed in priority on the prize advertisement menus, through the comparison of the tendency analysis result of the user with the prize advertisements of the sponsor.

The above method secures the advertisement effect with a higher hit rate for sponsors, enables the users to view the advertisements more related to their interest field, and secures the balanced advertisement opportunities between advertisement sponsors.

### BACKGROUND OF THE INVENTION

1. Field of the Invention

The present invention relates to a method for transmitting advertisements via electronic mails, and more particularly to a method for transmitting advertisements via electronic mails improved with an additional technology of enabling target advertisements to be performed by grasping users' tendencies with the use of hierarchical surveys, and of enabling prizes advertisement menus displayed to users to be effectively constructed, in a method for transmitting advertisements via electronic emails capable of sending e-mails including advertisements together with prize coupons through the internet.

2. Description of the Related Art

As a related art to the present invention, “System for electronic mail enclosing coupons and a method for transmitting the same” applied by the applicant of the present invention are pending with korean patent application No. 2000-28612. Hereinafter, with reference to FIG. 1 and FIG. 2, the related art disclosed in the patent application will be described.

FIG. 1a is a view for showing a structure of a system of electronic mails enclosing coupons, which is disclosed according to a first embodiment of the present invention. The system of electronic mails enclosing coupons according to the first embodiment of the present invention includes an information-providing server 10 for providing particular information, a prize-providing server 20 for providing advertisements inclusive of coupons, and a user computer 30, all of which are connected through the internet network 40.

FIG. 1b is a flow chart for showing a method of transmitting electronic mails enclosing coupons, which is disclosed according to the first embodiment of the present invention. First of all, the information-providing server 10 sends a user an electronic mail containing particular information together with a coupon(S100). The user confirms the received electronic mail enclosing the coupon and approves the receipt of the coupon (S110). The coupon is provided together with advertisements corresponding to it.

Thereafter, personal information on the user who receives the coupon, a prize-drawing number, and the like are stored in a database 22 of the prize-providing server 20(S120), and the prize-providing server 20 notifies the user who receives the coupon of whether he or she wins a prize(S130).

Here, the information-providing server 10 enables a user to directly choose and receive a coupon the user wants by transmitting a prize advertisements list page containing plural prize advertisements, rather than transmitting one coupon to the user.

As stated above, the first embodiment disclosed in the pending application is directed to a method for a company(that is, an information-providing server) to transmit an electronic mail enclosing a coupon to a customer(that is, a user). As a different method from the above, there is a method for sending electronic mails enclosing coupons in the transmissions of electronic mails between users, which is disclosed according to a second embodiment and described with reference to FIG. 2 hereinafter.

FIG. 2a is a view for showing a structure of a system of electronic mails enclosing a coupon, which is disclosed in the pending application according to the second embodiment of the present invention. The system of electronic mails enclosing a coupon according to the second embodiment includes an electronic mail service-proving service 200 for providing electronic mail services, a prize-providing server 210 in charge of providing advertisements including coupons, and plural user computers 220, which are connected through the internet network 230.

FIG. 2b is a flow chart for showing a system of electronic mails enclosing coupons according to the second embodiment, which is disclosed in a related art. First of all, a sender hooks up the electronic mail service-proving server 200 and prepares an electronic mail message(S300). Next, the sender who has written the message encloses a coupon in the electronic mail and sends the electronic mail to a receiver(S310). The receiver confirms the received electronic mail enclosing the coupon and approves the receipt of the coupon(S320). The coupon is provided together with corresponding advertisements.

At this time, personal information, a prize-drawing number, and the like of the user who has received the coupon are stored in a database 212 of the prize-providing server 210(S330), and the prize-providing server 210 notifies the receiver who has received the coupon of whether he wins the prize(S340).

As in the first embodiment, the second embodiment transmits a coupon advertisement list page containing plural prize advertisements, instead of transmitting one coupon, so that a user himself can directly choose and receive a prize he wants.

### SUMMARY OF THE INVENTION

Some application examples may exist for the advertisement-transmitting method using electronic mails enclosing coupons as stated above.

First of all, by asking a sender or a receiver who receives coupons some questions of a hierarchical structure during advertisement transmissions using an electronic mail which encloses the coupons, the tendencies of a user may be analyzed according to the answer information on the surveys accumulated with respect to the particular user. Such tendency analysis may be usefully employed for the target advertisements for particular users.

Further, the prior art discloses an embodiment in which a sender chooses a coupon to be transmitted from a prize advertisement list page containing plural prize advertisements, and an embodiment in which a receiver chooses a coupon to be received from a prize advertisement list page containing plural prize advertisements as stated above.

Prize advertisements existing on a web site of a prize-providing server may be numerous in number, and may not be shown on one web page. At this time, it is required to effectively construct prize advertisement menus.

That is, a prize advertisement menu related to a field of user's interest may be displayed in priority according to the tendency analysis information of a particular user from the surveys as stated above. Further, the balance between the advertisers may be obtained by displaying in priority the prize advertisements with a low click rate so far in an aspect of a relation between advertisers and a provider of a prize-providing server.

Accordingly, it is an object of the present invention to provide a method for transmitting advertisements via electronic mails, capable of asking some surveys of a hierarchical structure to a sender and a receiver who receives coupons during the advertisement transmissions using electronic mails which enclose the coupons, analyzing a tendency of a user according to information on answers to surveys accumulated with respect to the particular user and using the tendency analysis for target advertisements with respect to the particular user.

The connections of the surveys of such structure with electronic mail service enclosing coupons enables the response rate to the surveys to be heightened, advertisement effects of a high probability to be provided, and users to receive advertisements fit for their interest field.

Another object of the present invention is provided for matching an advertiser with a user suitable for the conditions of the advertiser based on the result of the tendency analysis of a user obtained through the surveys of such hierarchical structure, and automatically transmitting an electronic mail containing the advertisements of a particular advertiser to plural users suitable for the conditions, to thereby maximize the advertisement effect.

A further object of the present invention is provided for displaying a prize advertisement menu of a user's interest field in priority according to the information on the tendency analysis of the particular user based on surveys, to thereby realize an advertisement transmission method using electronic mails which encloses coupons efficiently, in addition to the provision of fair prize advertisement click rates between advertisers by displaying the prize advertisements of low clock rates on the prize advertisement menus in priority.

In order to achieve the above objects, in a method for transmitting advertisements via electronic mails in which the advertisements are enclosed together with coupons on the internet, the method comprises steps of: connecting to a web server for providing an electronic mail service by a sender who wishes to send an electronic mail, and preparing an electronic mail message; enclosing the coupons with the electronic mail, and sending the electronic mail by the sender; choosing that the sender himself receives the coupons as well; displaying questions regarding the sender on the sender's web browser according to the above choice; storing in a database of the prize-providing server the sender's answers to the questions as information on the sender's tendency; and notifying the sender of whether he or she wins a prize by the prize-providing server.

Further, in order to achieve another object of the present invention, in a method for transmitting advertisements via electronic mails enclosing the advertisements together with coupons on the internet, the method comprises steps of: connecting to a web server for providing an electronic mail service by a receiver of the electronic mail, and confirming an electronic mail message enclosing the received coupons; choosing that the receiver receives the coupons; displaying questions regarding the receiver on a web browser of the receiver according to the choice; storing in a database of the prize providing server receiver's answers to the questions as information on receiver's tendency; and notifying the receiver of whether he or she wins a prize by the prize-providing server.

Further, in order to achieve a further object of the present invention, in a method for transmitting advertisements via electronic mails enclosing advertisements together with coupons on the internet, the method comprises steps of: receiving conditions for target advertisements from sponsors; analyzing whether there are users fit for conditions of the sponsors through the information on the user's tendencies stored in the database of the prize providing server; and enclosing the target advertisements of the sponsors in the electronic mail together with coupons and automatically transmitting the electronic mail to the users fit for the conditions, in case that the number of the users satisfying the conditions of the sponsors meets a predetermined number.

Further, in order to achieve a still further object, in a method for transmitting advertisements via electronic mails enclosing the advertisements together with coupons on the internet, the method comprises steps of: connecting to a prize-providing server by a user; comparing and analyzing the tendency of the user stored in a user database of the prize-providing server with the advertisements stored in the advertisement database; constructing a priority order of advertisements fit for the tendency of the user according to the analysis through the sorting; and displaying the constructed advertisements on a web browser of the user, wherein prize-providing menus are provided to the user.

Furthermore, in order to achieve a furthermore object of the present invention, in a method for transmitting advertisements via electronic mails enclosing the advertisements together with coupons on the internet, the method comprises steps of: connecting to a prize-providing server by a user; constructing a priority order of the advertisements to be provided to the user through ranking and sorting based on click rates of the advertisements up to date; and displaying the constructed advertisements on a web browser of the user, wherein prize-advertisement menus are provided to the users.

### BRIEF DESCRIPTION OF THE DRAWINGS

The above objects and other advantages of the present invention will become more apparent by describing in detail a preferred embodiment thereof with reference to the attached drawings, in which:

FIG. 1a is a view for showing a structure of a system of electronic mails in which coupons are enclosed, according to a first embodiment of a related art;

FIG. 1b is a flow chart for showing a method for transmitting electronic mails in which coupons are enclosed, according to a first embodiment of a related art;

FIG. 2a is a view for showing a structure of a system of electronic mails in which coupons are enclosed, according to a second embodiment of a related art;

FIG. 2b is a flow chart for showing a method for transmitting electronic mails in which coupons are enclosed, according to a second embodiment of a related art;

FIG. 3 is a view for showing a database of a hierarchical survey system according to an embodiment of the present invention;

FIG. 4a is a flow chart for showing, in the side of a sender, a method for transmitting advertisements using electronic mails which use hierarchical surveys according to the present invention;

FIG. 4b is a flow chart for showing, in the side of a receiver, a method for transmitting advertisements using electronic mails which use hierarchical surveys according to the present invention;

FIG. 5 is a flow chart for showing a method for automatically transmitting plural electronic mails in which target advertisements are included according to the present invention;

FIG. 6a is a flow chart for showing a method for constructing prize advertisement menus displayed to a user according to a first embodiment of the present invention; and

FIG. 6b is a flow chart for showing a method for constructing prize advertisement menus displayed to a user according to a second embodiment of the present invention.

### DETAILED DESCRIPTION OF THE PREFERRED EMBODIMENTS

Hereinafter, preferred embodiments of the present invention will be described in detail with reference to the accompanying drawings.

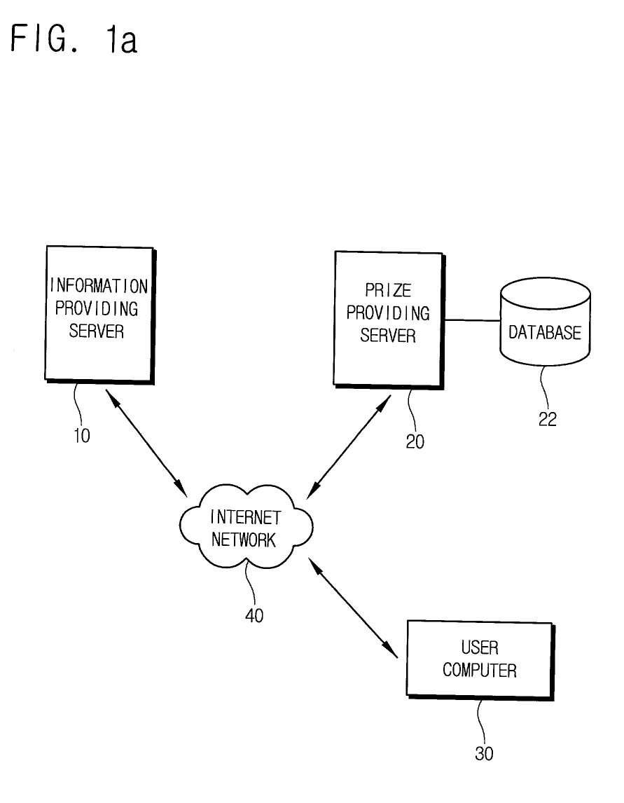

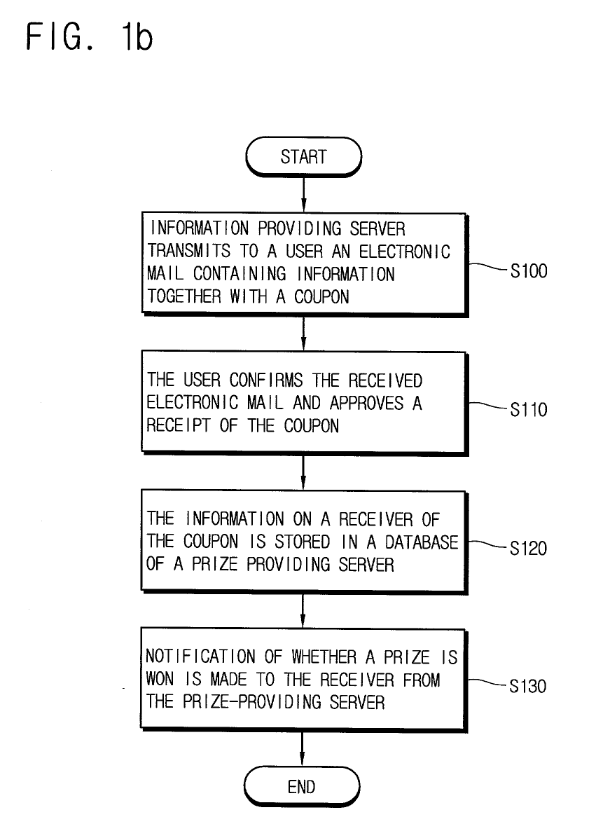

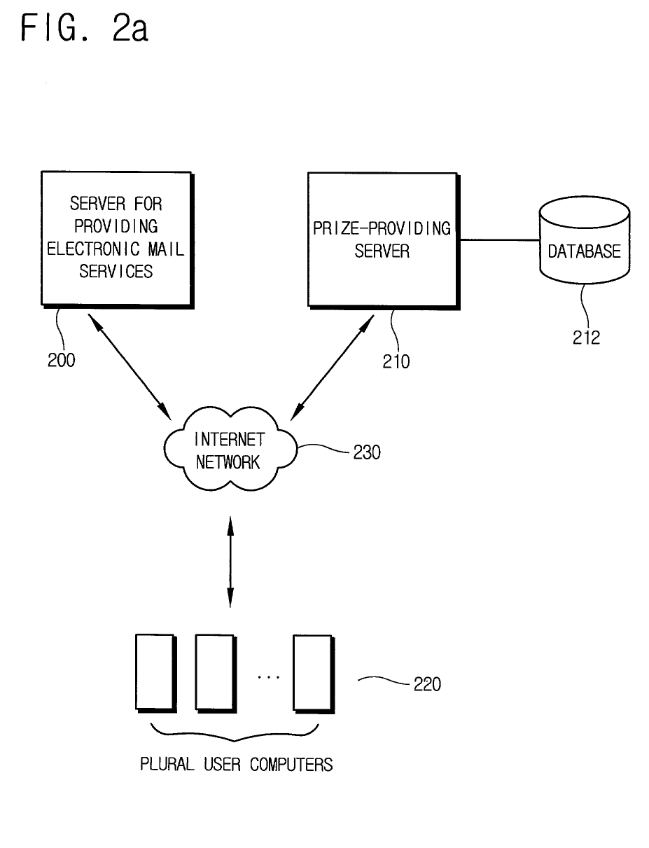

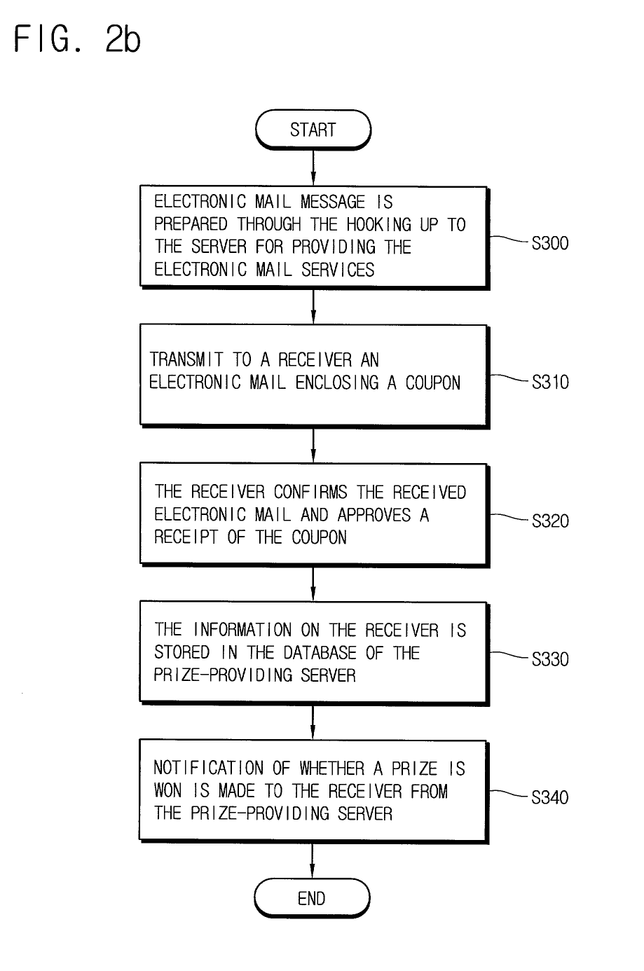

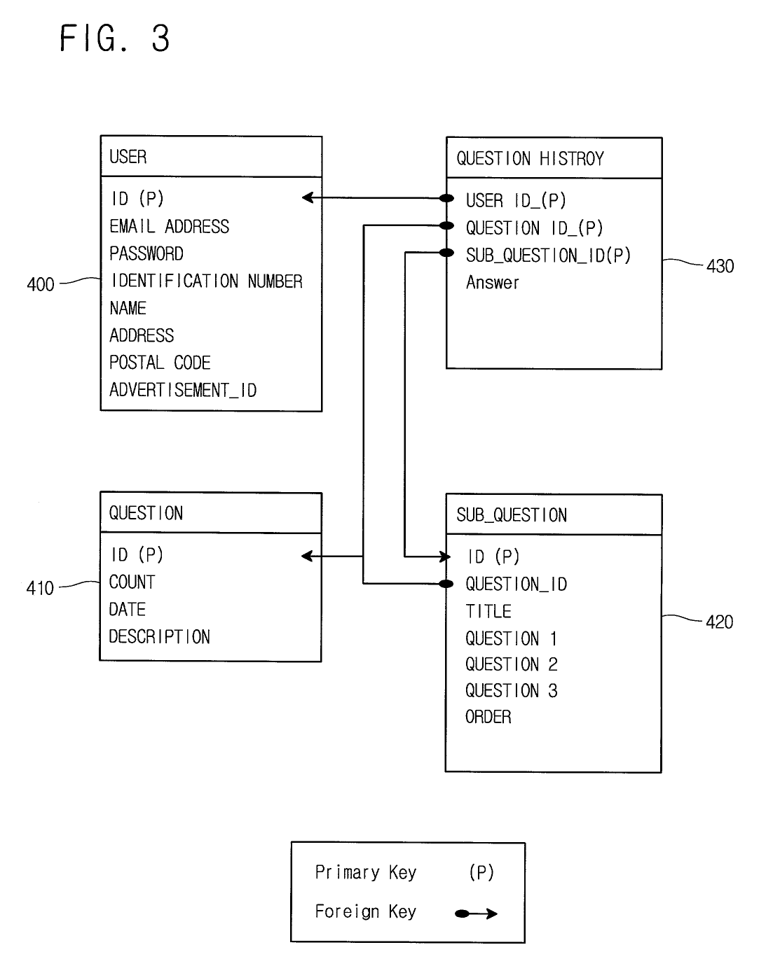

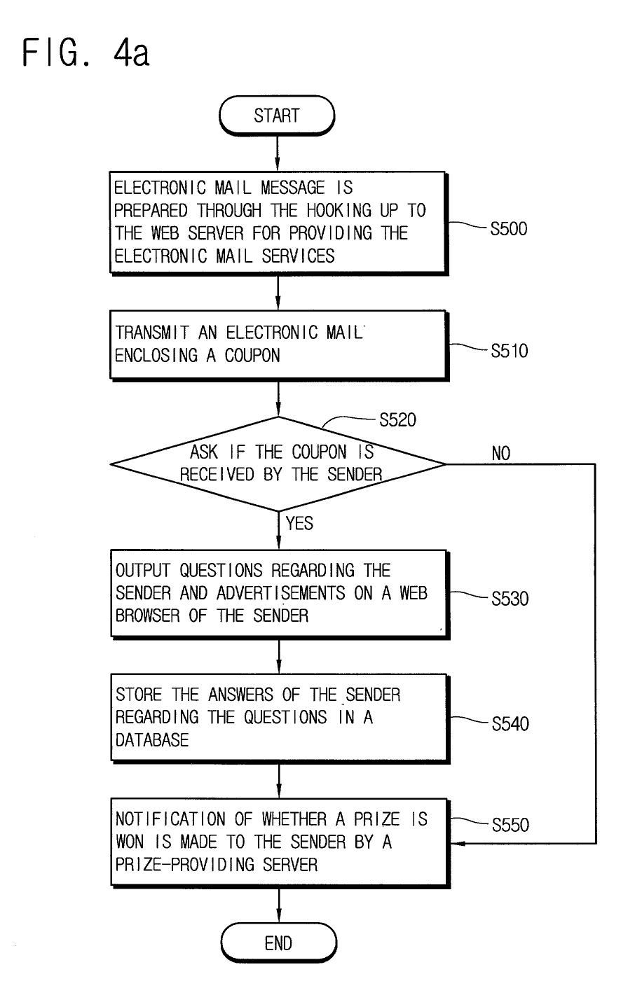

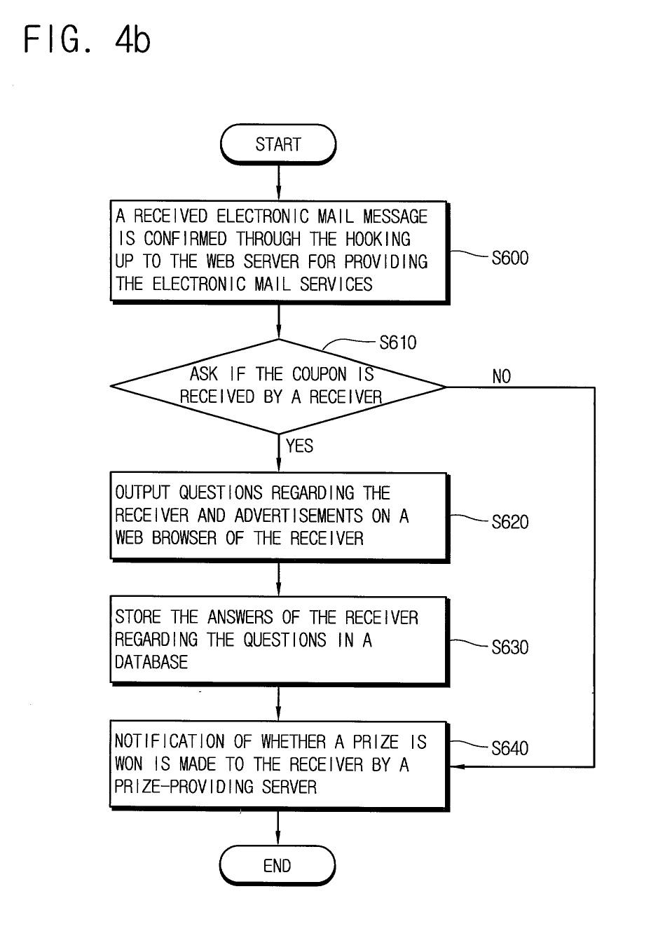

First of all, a description on a hierarchical survey system according to the present invention applied for advertisement transmissions using electronic mails in which coupons are enclosed will be made with reference to FIG. 3 and FIG. 4. The system environments for operating the survey system are the same as those of the related art(refer to FIG. 1a and FIG. 2a).

The hierarchical survey system can be built in advance and stored in a database by the operator of a prize-providing server, or prepared and stored by advertisement agents who are requested by advertisers. The surveys to be provided are constituted with questions suitable for obtaining the tendencies of users such as preferences, interested fields, and the like.

Such questionnaires for the surveys are provided to have plural hierarchical structures. That is, if a first-step question of the uppermost goes to “What do you do for your extra activity?” and a user's answer to the question goes to “sports”, a second-step question may hierarchically go to “What sports do you like?”.

Such questions are provided not to be duplicated to the same user. For example, in case that the first-step question is answered when using a service of an electronic mail in which a coupon is enclosed, the answer is stored in the database, and when the same user uses the service next time, a corresponding second-step question is made. However, It is not imperative that one question is accompanied for every service, but there can be various modifications.

FIG. 3 is a view for showing a database for a hierarchical survey system according to an embodiment of the present invention.

The database of the hierarchical survey system according to the present invention includes a user table 400, a question table 410, a sub-question table 420, and a question history table 430. It is assumed that the embodiment of the present invention carries out three-step questions.

The user table 400 has the primary key of ID, which stores electronic mail addresses, identification numbers, names, and postal codes for users and information on an advertisement chosen by a user can be stored in an advertisement_ID. The question table 410 stores information Count (descriptions) regarding the categories of questions and information regarding the number of questions.

The sub-question table 420 stores respective questions, for example, question 1 to question 3, and information regarding the sequences of the questions to be provided to the users in the category question system.

The question_history table 430 contains information regarding which question a user have answered, and the user's answer to the question is stored in the Answer field with reference to the user_ID of the user table 400, the question_ID of the question table 410, and the sub question_ID of the sub₁₃question table 420.

FIG. 4a and FIG. 4b are views for showing steps of applying hierarchical questions according to the embodiment of the present invention, in an advertisement transmission using an electronic mail in which a coupon is enclosed. FIG. 4a is a view for showing the responses to a question in the side of a sender, and FIG. 4b is a view for showing the responses to a question in the side of a receiver.

FIG. 4a is a flow chart for showing, in the side of a sender, a method for transmitting advertisements using an electronic mail in which hierarchical questions are employed according to an embodiment of the present invention.

First of all, a sender of an electronic mail hooks up to a web server for providing an electronic mail service and prepares an electronic mail message(S500). The web server for providing the electronic mail service may be a prize-providing server or a web server for providing only the electronic mail service.

Next, the sender chooses a coupon to be transmitted and sends an electronic mail together with the chosen coupon(S510). At this time, the coupon chosen to be sent by the sender is transmitted to the receiver, but the sender may receive the coupon as well. Accordingly, the sender determines whether he receives the coupon(S520).

If the sender chooses the receipt of the coupon, questions about the sender are displayed on a web browser of the sender together with the receipt of the coupon(S530), and sender's answers to such hierarchical questions are stored in a database of the prize-providing server(S540). Lastly, the prize-providing server notifies the sender of whether he wins the prize and all steps are ended, wherein the notification of whether he wins the prize can be instantly made according to the kinds of the prizes or the future confirmation can be made by hooking up the prize-providing server on a drawing date(S550). Corresponding advertisement contents are displayed together with the coupon or the questions during the steps, to thereby obtain advertisement effects that the advertisers intend.

FIG. 4b is a flow chart of showing, in the side of a receiver, a method for transmitting advertisements using electronic mails which hierarchical questions are employed according to the present invention.

First of all, a receiver of an electronic mail hooks up a web server for providing an electronic mail service and confirms electronic mail messages received together with coupons(S600). The web server through which the electronic mail service is provided may be a prize-providing server or a web server for providing only the electronic mail service.

Next, the receiver chooses whether he receives the coupon enclosed in the electronic mail(S610). If the receiver chooses the receipt of the coupon, questions regarding the receiver are displayed on a web browser of the receiver are displayed together with the receipt of the coupon(S620), and the receiver's answers to such hierarchical questions are stored in the database of the prize-providing server(S630). Lastly, the prize-providing server notifies the receiver of whether he wins the prize and all the steps are ended(S640). Still, the corresponding advertisement contents are displayed together with the coupon or questions during the steps, to thereby bring the advertisement effects that the advertisers intend.

In the embodiments shown in FIG. 4a and FIG. 4b, the information regarding the tendencies of the users stored in the database of the prize-providing server is used for target advertisements based on the information. That is, advertisements for goods fit for the tendencies of the users are made to the users through electronic mails, which may be limited to the cases that the users accept the receipts of the advertisement mails.

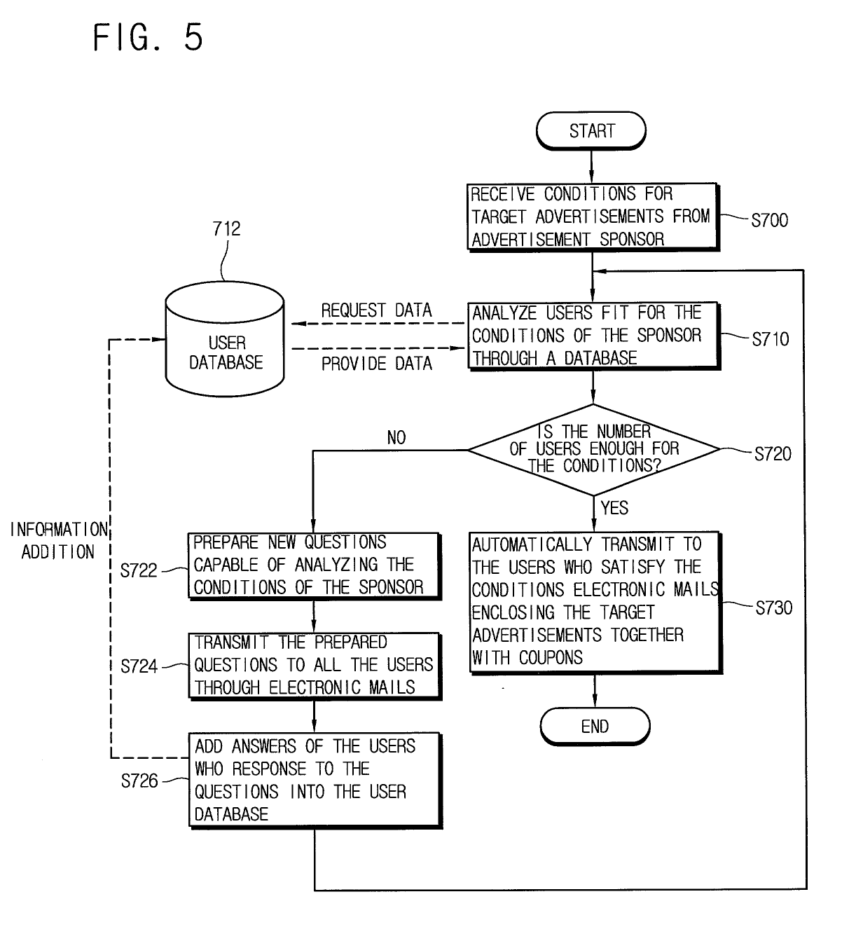

Further, with reference to FIG. 5, a method for automatically transmitting plural electronic mails in which target advertisement are contained based on the tendency information on the users collected through the above steps will be described.

As shown in FIG. 3, the user database basically includes data fields such as a user name, an identification number, an address, a postal code, and the like. Further, the basic data fields of a user is added to the tendency information of the user by the hierarchical question system, to thereby form a basis from which the target advertisements can be done.

FIG. 5 is a flow chart for showing a method for automatically transmitting plural electronic mails in which advertisements are contained, according to the embodiment of the present invention.

First of all, a sponsor offers some conditions for the target advertisements and entrusts the advertisements, and the prize-providing server accepts the offer(S700). Thereafter, comparisons and analyses with respect to whether there are users who are fit for the conditions of the sponsor are performed through the information regarding the users' tendencies stored in the user database 712 of the prize-providing server by the above hierarchical question method(S710).

During the analyses, the user who are suitable for the conditions are chosen through the integrated analyses of various conditions that the sponsor offer, such as the tendency and preference of a user, the number of advertisement electronic mails to be transmitted, time, regions, and the like, based on the user database 712.

For example, if a target advertisement is to be planed for a Korean restaurant which is newly opened in a region by using the system according to the present invention, first of all, users are chosen who have addresses near the region and like Korean food in the tendency-analyses through the hierarchical questions.

Next, the step(S720) proceeds for determining whether the number of the users who are chosen through the above analyses is enough for advertisements. If the number of the chosen users is enough for advertisements, the target advertisements for the sponsor are automatically transmitted to the chosen users through electronic mails enclosing coupons(S730).

If the number of the chosen users in the step S720 does not reach the number enough for the advertisements, new questions are prepared for the analyses of the conditions offered by the sponsor(S722), and the new prepared questions are transmitted to all the users through electronic mails enclosing coupons(S724) . Next, the information on the users who response to the questions is additionally stored in the database of the prize-providing server(S726), and the analyses step is carried out in the step S710 based on the newly added information.

As stated above, in a method for transmitting advertisements together with coupons, there exists an embodiment in which a prize advertisement list page containing plural prize advertisements rather than simple coupons is employed. In such case, what is important is how to arrange numerous prize advertisements on the web browser screen.

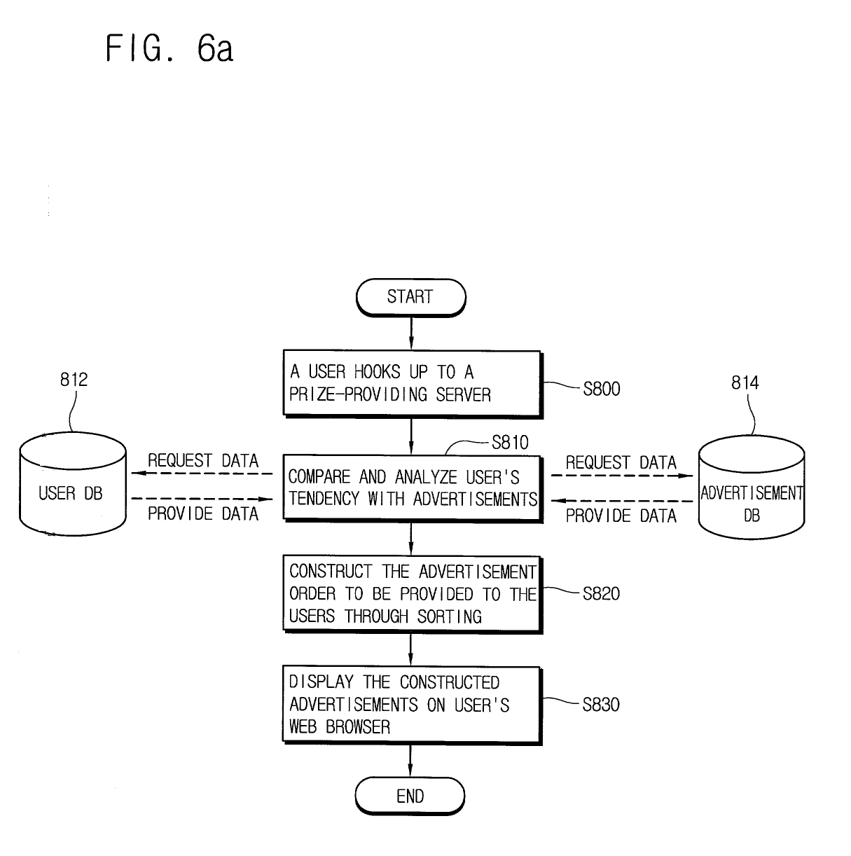

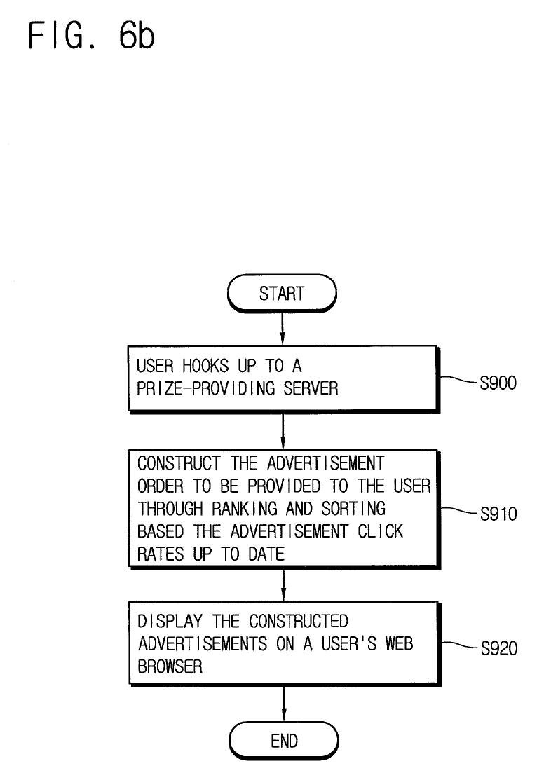

Accordingly, a method is provided for maximizing advertisement effects in view of sponsors and rapidly choosing necessary prize advertisements in view of users, and a method is provided for building a structure of more balanced prize advertisement menus between the sponsors, with reference to FIG. 6.

FIG. 6a is a flow chart for showing a method for constructing prize advertisement menus displayed for users according to a first embodiment of the present invention. The first embodiment of FIG. 6a is also based on the information of the users' tendencies obtained through the hierarchical questions of the present invention.

First of all, a user is connected to a prize-providing server(S800). The connections of the user includes a connection for directly transmitting electronic mails from the prize-providing server and a connection at the time when choosing the transmissions of electronic mails together with coupons after preparing electronic mail messages in a different server for providing electronic mail services.

Next, the data of a user database 812 as well as the data of an advertisement database 814 is compared and analyzed(S810), and the order for the advertisements to be provided to specified users is constructed through a sorting process(S820), wherein the data of the user database 812 stores the basic information of specified users who are connected, such as ages, addresses, and the like, and the information on the users' tendencies collected through the hierarchical questions of the present invention, such as users' preferences, purchase characteristics, and the like, and the data of the advertisement database 814 stores the information on prize advertisements of sponsors. That is, if a user answers his address is Region 1 and his preference in food is Japanese food in the questions for a certain time period, the priority order is determined from prize advertisements with respect to Japanese restaurants located in Region 1.

Accordingly, the step S830 proceeds for outputting built advertisements on a web browser of a user. That is, if the prize advertisement menu is displayed on a web browser in the form of a list page, the most related advertisements are arranged in the position of the highest visibility, in a manner that the advertisements most related to the user's tendency are disposed on the top of the list. Further, in case that there exists plural prize list pages, the first list page is built with the advertisements most related to a particular user's tendency. Such a structure of a prize advertisement menu brings advertisement effects having a higher hit rate in store for sponsors, and enables the users to view the prize advertisements more necessary for them.

FIG. 6b is a flow chart for showing a method for constructing prize advertisement menus displayed to users according to a first embodiment of the present invention. The second embodiment of FIG. 6b is for securing prize advertisement click rates balanced between sponsors.

First of all, a user is connected to a prize-providing server(S900). Next, the order of the advertisements to be provided to the user is constructed through the ranking and sorting based on the click rates of prize advertisements(that is, coupons) up to date(S910). That is, a priority is given to a prize advertisement statistically lowest in the rate chosen as a coupon by users up to date.

Accordingly, the step S920 proceeds for outputting advertisements constituted on the web browser of a user. That is, if the prize advertisement menus are displayed on the web browser in the form of a list page, an arrangement is made on the position of the highest visibility from the advertisement lowest in a click rate in the manner that the advertisement lowest in a chosen rate up to date is positioned on top of the list. Further, in case that there exists plural prize list pages, the first list page is constituted with the advertisements lowest in the click rate. Therefore, balanced advertisement opportunities are secured between sponsors with the construction of the above prize advertisement menus.

Further, it is easily understood by those skilled in the art that embodiments to be used together with the steps of FIG. 6a and FIG. 6b are possible.

As stated above, according to the present invention, the information on the tendencies of specified users is applied to the transmissions of electronic mails enclosing coupons, and target advertisements are carried out with the information collected as above, so that sponsors may be provided with effective advertisement effects having a high possibility and users may receive advertisements fit for their fields of interest.

Further, according to the present invention, users' tendencies obtained through questions having such a hierarchical structure are compared and analyzed together with the conditions of sponsors, and electronic mails containing the advertisements of particular sponsors are automatically transmitted to plural users fit for the conditions, so that the advertisement effects are maximized.

Furthermore, according to the present invention, displaying a prize advertisement menu of an interest field of a particular user in priority realizes more efficient advertisements with a high probability, and displaying in priority the prize advertisements lowest in the click rates on a prize advertisement menu has an effect of securing the balanced click rates between sponsors.

Although the preferred embodiments of the present invention has been described, it will be understood by those skilled in the art that the present invention should not be limited to the described preferred embodiments, but various changes and modifications can be made within the spirit and scope of the present invention as defined by the appended claims.

What is claimed is:

1. A method for transmitting advertisements via electronic mails in which the advertisements are enclosed together with coupons on the internet, the method comprising steps of:
connecting to a web server for providing an electronic mail service by a sender who wishes to send an electronic mail, and preparing an electronic mail message;
enclosing the coupons with the electronic mail, and sending the electronic mail by the sender;
choosing that the sender himself receives the coupons as well;
displaying questions regarding the sender on the sender's web browser according to the above choice;
storing in a database of the prize providing server the sender's answers to the questions as information on the sender's tendency; and
notifying the sender of whether he or she wins a prize by the prize providing server.

2. A method for transmitting advertisements via electronic mails enclosing the advertisements together with coupons on the internet, the method comprising steps of:
connecting to a web server for providing an electronic mail service by a receiver of the electronic mail, and confirming an electronic mail message enclosing the received coupons;
choosing that the receiver receives the coupons;
displaying questions regarding the receiver on a web browser of the receiver according to the choice;
storing in a database of the prize providing server receiver's answers to the questions as information on receiver's tendency; and
notifying the receiver of whether he or she wins a prize by the prize providing server.

3. The method as claimed in claim 1 or 2, wherein the questions are suitable for grasping personal preferences and purchase tendencies of the sender or the receiver, and the questions are in a hierarchical structure with questions of an upper concept and question of a lower concept.

4. The method as claimed in claim 1 or 2, wherein the information on the tendencies of the sender or the receiver stored in the database of the prize-providing server is employed for target advertisements through electronic mails based on the information.

5. A method for transmitting advertisements via electronic mails enclosing advertisements together with coupons on the internet, the method comprising steps of:
receiving conditions for target advertisements from sponsors;
analyzing whether there are users fit for conditions of the sponsors through the information on the user's tendencies stored in the database of the prize providing server by the method of claim 1 or 2; and
enclosing the target advertisements of the sponsors in the electronic mail together with coupons and automatically transmitting the electronic mail to the users fit for the conditions, in case that the number of the users satisfying the conditions of the sponsors meets a predetermined number.

6. The method as claimed in claim 5, in case that the number of the users satisfying the conditions of the sponsors does not meet the predetermined number, further comprising steps of:
preparing new questions capable of analyzing the conditions received from the sponsor;
transmitting the prepared new questions to all the users via electronic mails enclosing coupons; and
storing in the database in the prize-providing server the answers of the users who response to the questions.

7. A method for transmitting advertisements via electronic mails enclosing the advertisements together with coupons on the internet, the method comprising steps of:
connecting to a prize-providing server by a user;
comparing and analyzing the tendency of the user stored in a user database of the prize providing server with the advertisements stored in the advertisement database;
constructing a priority order of advertisements fit for the tendency of the user according to the analysis through the sorting; and
displaying the constructed advertisements on a web browser of the user, wherein prize advertisement menus are provided to the user.

8. A method for transmitting advertisements via electronic mails enclosing the advertisements together with coupons on the internet, the method comprising steps of:
connecting to a prize providing server by a user;
constructing a priority order of the advertisements to be provided to the user through ranking and sorting based on click rates of the advertisements up to date; and
displaying the constructed advertisements on a web browser of the user, wherein prize advertisement menus are provided to the users.

9. The method as claimed in claim 7, wherein the step for constructing the order of the advertisements to be provided to the users arranges the advertisements at positions from most visible to less visible on the prize advertisement menus in the order from the advertisements most related to the user's tendency to the advertisements less related to the user's tendency.

10. The method as claimed in claim 8, wherein the step for constructing the order of the advertisements to be provided to the users through the ranking and sorting arranges the advertisements at positions from most visible to less visible on the prize advertisement menus in the order from the advertisements lowest in a click rate to the advertisements highest in the click rate up to date.
